(19) United States
(12) Patent Application Publication
(10) Pub. No.: US 2013/0253974 A1
(43) Pub. Date: Sep. 26, 2013

(54) System And Method For Inspecting And Assessing Risk of Mechanical Equipment And Facilities

(71) Applicant: Technical Standards And Safety Authority, Toronto (CA)

(72) Inventors: Srikanth MANGALAM, Mississauga (CA); Lency Abraham MULAMOOTIL, MISSISSAUGA (CA); Arun VEERAMANY, Mississauga (CA)

(73) Assignee: Technical Standards And Safety Authority, Toronto (CA)

(21) Appl. No.: 13/894,705

(22) Filed: May 15, 2013

Related U.S. Application Data
(63) Continuation-in-part of application No. 13/309,707, filed on Dec. 2, 2011, now Pat. No. 8,463,635.

(51) Int. Cl. G06Q 10/06

(52) U.S. Cl. CPC G06Q 10/06315
USPC 705/7.25

(57) ABSTRACT

A method for determining a risk of mechanical or electrical failure and for determining an inspection interval to mitigate said risk; the method including determining by a computer system an acceptable risk score based on computer readable instructions provided on a non-transitory computer readable medium, determining by said computer system an inspection interval based on said risk score, determining by said computer system a tolerance within said inspection interval based on said increased risk; and, specifying by said computer system an inspection interval and an inspection tolerance based on said determined schedule and said determined tolerance.

### FIELD OF THE INVENTION

The present invention relates generally to the field of inspecting equipment and facilities typically subject to regimented inspection intervals, for example people moving devices such as elevators and facilities and equipment used for storing and/or dispensing fuels and other materials.

### BACKGROUND OF THE INVENTION

Periodic inspections of elevator and other people moving devices are essential to ensure safe operations in these devices. Both minor and catastrophic failures in elevating devices can lead to significant short term human injury and/or chronic long term injuries that present significant public safety risks. This is particularly true in elevating devices that are designed to move a volume of people at a given time. Accordingly, various governmental quasi-governmental, and similar agencies have been put in place to ensure the proper operation, maintenance and inspection of elevating devices. With regards to inspections, prior art methods generally operate on a mandated inspection interval. When these inspections are missed, or are late, whether due to a shortage of inspection personnel, physical limitations or other unaccounted for circumstances, prior art systems have been unable to adapt accordingly.

Similarly, periodic inspections of fuel handling and storage facilities are essential to ensure safe operation and use of these devices, particularly under strict regulatory regimes. Minor and catastrophic failures can lead to significant consequences as described above.

The prior art has been unable to handle the case of missed or delayed inspections and/or maintenance operations other than on an ad hoc basis, or otherwise rushing to complete a delayed inspection and/or maintenance as soon as possible. In an era of limited resources, or where such schedules are altogether unreasonable, it would be beneficial to provide an improved system and method that dynamically adapts as maintenance and/or inspections are not carried out with respect to a fixed schedule.

### SUMMARY OF THE INVENTION

According to one embodiment of the invention, there is provided a method for determining a risk of failure in a people moving device and for determining an inspection interval to mitigate the risk, the method includes the steps of determining an acceptable risk score, determining an inspection interval based on the risk score, determining an increase in risk score proportional to a time elapsed since an expected inspection in the inspection interval if the expected inspection has been missed, determining a tolerance within the inspection interval based on the increased risk, and, specifying an inspection interval and an inspection tolerance based on the determined schedule and the determined tolerance.

According to one aspect of this embodiment, the step of determining an acceptable risk score comprises selecting the maximum of an operational risk score and a device incident risk score. Preferably, the operational risk score is calculated based on observed and/or measured incident occurrences of the people moving device, and wherein the device incident risk score is calculated based on historical failure data.

According to another aspect of this embodiment, the operational risk score is calculated based on the equation R_{D}=f_{b}*D, where f_{b} is the frequency of incident occurrences per year; and, D is a measure of life years expected to be lost as a result of the occurrences by occurrence type. D is calculated based on equation D=SW*SD+FL*LW*LD; where SW is a short-term weight, SD is a short-term duration effect measured in years, FL is a fraction representative of the long-term versus short-term effects, LW is a long-term weight, and LD is a long-term duration effect measured in years.

According to another aspect of this embodiment, a device operational risk score is calculated as a summation of each of the individual operational risk scores.

According to another aspect of this embodiment, the people moving device is identified as one of a high risk device, a medium risk device and a low risk device.

According to another aspect of this embodiment, the high risk device is one where the value of D is equal to or greater than 4.5×10⁻⁴; the medium risk device is one where the value of D is between 4.5×10⁻⁴ and 6.7×10⁻⁶ and the low risk device is one where the value of D is less than 6.7×10⁻⁶.

According to another aspect of this embodiment, the method further includes the step of initiating an inspection of the people moving device if the people moving device is identified as a high risk device.

According to another aspect of this embodiment, the step of determining an inspection interval comprises calculating an inspection interval tₘ or tₗ based on the equations for medium and low risk devices, respectively:

$${t}_{M} = 12 - \frac{1}{0.7} LN [ \frac{{R}_{M}}{6.7 \times {10}^{- 6}} ]$$

$${t}_{L} = 18 - \frac{1}{1.21} LN [ \frac{{R}_{L}}{4.713 \times {10}^{- 9}} ]$$

According to another aspect of this embodiment, the step of determining an increase in risk score comprises calculating an increased risk score R_{M} or R_{L}, based on the equations for medium and low risk devices, respectively:

R_{M}=6.7×10⁻⁶exp[0.7(12−(t_{M}−od))]

R_{L}=2.4×10⁻⁶exp[1.322(18−(t_{L}−od))]

where od is the time elapsed since an expected inspection.

According to another aspect of this embodiment, the method further includes the step of using the increased risk score to determine if the increased risk is a high, medium or low risk.

According to another aspect of this embodiment, the people moving device is an elevator.

According to another embodiment of the invention, there is disclosed a system for determining a risk of failure in a people moving device and for determining an inspection interval to mitigate the risk. The system preferably includes a module for determining an acceptable risk score, a module for determining an inspection interval based on the risk score, a module for determining an increase in risk score proportional to a time elapsed since an expected inspection in the inspection interval if the expected inspection has been missed, a module for determining a tolerance within the inspection interval based on the increased risk and a module for specifying an inspection interval and an inspection tolerance based on the determined schedule and the determined tolerance.

According to various other aspects of this embodiment, the system is adapted to carry out the various method steps described above. Preferably, the people moving device is an elevator, and the system is a computer system associated with the elevator.

According to another embodiment of the invention, there is provided a method for determining a risk of mechanical or electrical failure and for determining an inspection interval to mitigate said risk; the method comprising determining by a computer system an acceptable risk score based on computer readable instructions provided on a non-transitory computer readable medium; determining by said computer system an inspection interval based on said risk score; determining by said computer system a tolerance within said inspection interval based on said increased risk; and,

specifying by said computer system an inspection interval and an inspection tolerance based on said determined schedule and said determined tolerance; wherein said step of determining an inspection interval comprises calculating an inspection interval tₘ or tₗ based on equations (3) and (4) for medium and low risk devices, respectively:

$$\begin{matrix}{t}_{M} = 12 - \frac{1}{0.7} LN [ \frac{λ}{6.7 \times {10}^{- 6}} ] & ( 3 ) \\ {t}_{L} = 18 - \frac{1}{1.21} LN [ \frac{λ}{4.713 \times {10}^{- 9}} ] & ( 4 )\end{matrix}$$

where t_{M} and t_{L} are measured in months, and λ is an acceptable risk score;

and wherein said step of determining of determining an acceptable risk score comprises calculating λ based on equation (5)

$${λ}_{d} = \frac{{\sum }_{i} {SRR}_{i} * {D}_{i}}{{\sum }_{i} {D}_{i}} \qquad ( 5 )$$

where

SRRᵢ is the ith operational risk score for the facility d

Dᵢ is the time duration in years between inspection dates corresponding to SRRᵢ₋₁ and SRRᵢ.

According to an aspect of this embodiment, the operational risk score is calculated based on the equation (1):

SRR=f_{b}*D (1)
where f_{b} is the frequency of incident occurrences per year; and,
D is a measure of life years expected to be lost as a result of said occurrences by occurrence type, and is calculated based on equation (2):

D=SW*SD+FL*LW*LD (2)
where:
SW is a short-term weight,
SD is a short-term duration effect measured in years,
FL is a fraction representative of the long-term versus short-term effects,
LW is a long-term weight, and
LD is a long-term duration effect measured in years.

According to another aspect of this embodiment, the method is applied to a fuel storage device or a fuel storage facility.

According to another aspect of this embodiment, the method for includes determining a cumulative time-dependent risk curve based equation (6)

R_{d}(t)=(λt)^{p}D (6)
where
R_{d}(t) is the cumulative risk up to time t for facility d.
λ_{d}=λ/D is the occurrence rate expressed as occurrences per year.
D=is a constant representing average health impact observed in any given year.
t is the time since the last inspection.
p is the shape factor independent of the facility, determined by fitting a statistical distribution to a dataset containing a time to first occurrence signifying underlying failure since the last periodic inspection;
wherein said time dependent risk curve is used to determine an increase in risk score from a time proportional to a time elapsed since a previous inspection.

According to another embodiment of the invention, there is disclosed a computer readable medium having computer executable instructions thereon for carrying out the method according to the invention as herein described.

### BRIEF DESCRIPTION OF THE DRAWINGS

Embodiments will now be described, by way of example only, with reference to the attached Figures, wherein:

FIG. 1 is shows a top-level system according to the invention.

FIG. 2 shows a computer system that may be used to implement the invention.

FIG. 3 shows a system according to the invention.

FIG. 4 illustrates the relationship between inspection intervals and risk score as calculated according to the invention.

FIG. 5 is a flowchart showing a method according to the invention.

FIG. 6 illustrates the modeling of accumulation of risk scores after a missed inspection according to the invention.

FIG. 7 illustrates risk aggregation according to the invention.

FIG. 8 illustrates a risk tolerance curve according to another embodiment of the invention.

FIG. 9 is a flowchart showing a method according to a further embodiment of the invention.

FIG. 10 is a flowchart showing a method incorporating a time-to-compliance embodiment of the invention.

FIGS. 11 to 13 show various risk curves of each of the occurrence types used in the method of FIG. 10.

### DETAILED DESCRIPTION OF THE EMBODIMENTS

Elevator and Other People Moving Devices

The problem associated with the inspection of people mover devices, such as elevators, has previously been addressed on a purely qualitative basis or otherwise as mandated on a fixed schedule, without due regard to physical and/or historical risks associated with particular elevating devices. The invention, accordingly provides a heuristic approach that provides solutions for complex risk aggregation problems occurring in elevating devices. In the context of this application, non-compliances found during inspections are considered hazards to the safe operation of the elevator device and are identified as basic risk elements. The proposed method and system for operational risk quantification in elevating devices involves the characterization of, for example, frequency associated with an occurrence type (mechanism by which hazard would be realized) given non-compliance, human exposure, operational cycles, mechanical failures, and consequences. While the disclosure herein is described variably with respect to inspection and maintenance schedules, and the preferred embodiment is with respect to inspection of elevating devices, it will become apparent to a person skilled in the art that the teachings of the invention are equally applicable to maintenance schedules, and the terms can be read interchangeably in context throughout the application. As will become apparent to a person skilled in the art from the description below, quantification of safety goals in terms of different injury severities provide a means of ranking the elevators based on their operational risk scores in a coherent way, and scheduling of their inspections in a consistent way. Based on the maximum tolerability limit, backlog criteria for devices with the missed inspections are established.

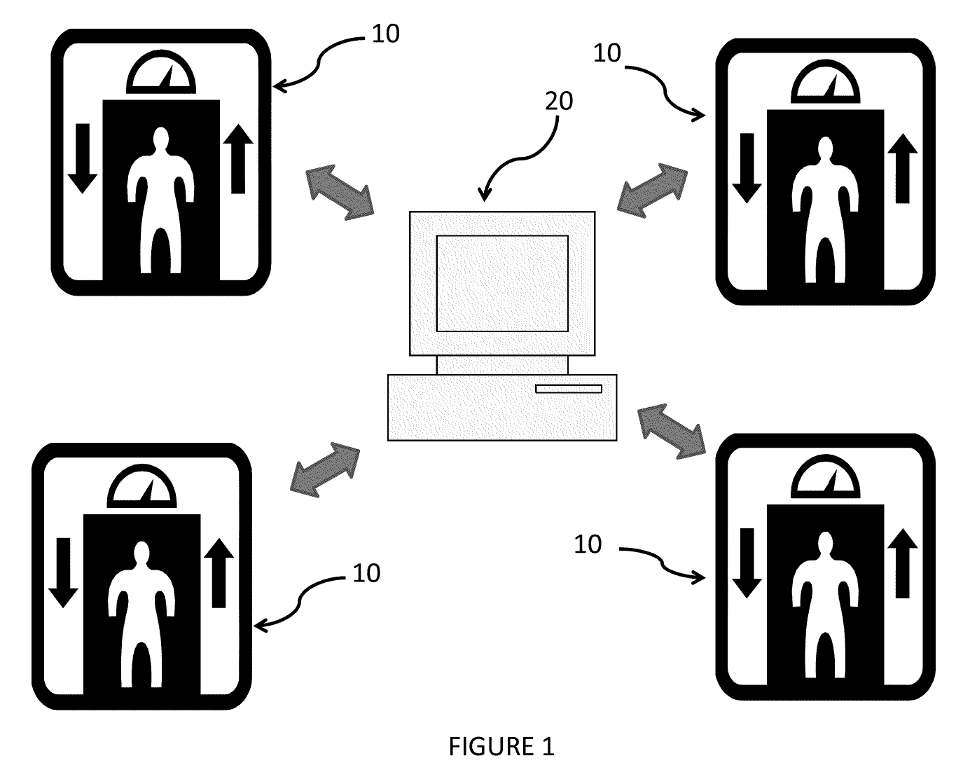

Referring now to FIG. 1, there is shown a general system according to the invention, including an elevator device 10 having an associated with computer system 20. In general, there will be a plurality of elevator, or other people moving devices, 10 having an associated computer system 20 from where, the invention in part is carried out. In some embodiments, various elements of the invention are located within the elevator device 10. For the purposes of the invention, computer system 20 may include a plurality of computer systems in communication with each other. Various functional modules are provided on the computer system 20 for carrying out aspects of the invention as will be discussed in more detail below.

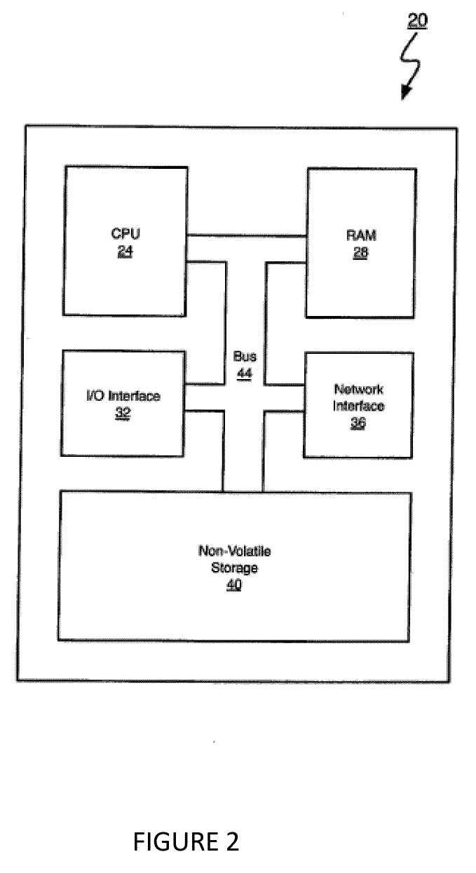

Referring now to FIG. 2, there is shown a general computer system 20 that includes a number of physical and logical components, including a central processing unit (“CPU”) 24, random access memory (“RAM”) 28, an input/output (“I/O”) interface 32, a network interface 36, non-volatile storage 4, and a local bus 44 enabling the CPU 24 to communicate with the other components. The CPU 24 executes an operating system, and a number of software systems and/or software modules. RAM 28 provides relatively-responsive volatile storage to the CPU 24. The I/O interface 32 allows for input to be received from one or more devices, such as a keyboard, a mouse, etc., and outputs information to output devices, such as a display and/or speakers. The network interface 36 permits communication with other elements of the invention described herein as being in networked communication with each other. Non-volatile storage 4 stores the operating system and programs. During operation of the computer system, the operating system, the programs and the data may be retrieved from the non-volatile storage 4 and placed in RAM 28 to facilitate execution.

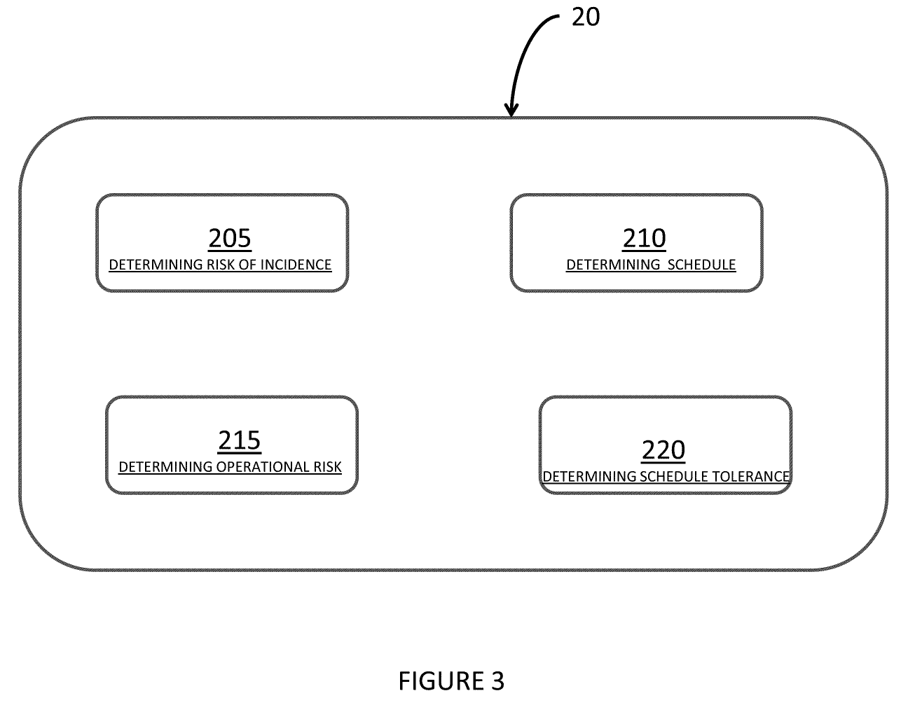

With reference now to FIG. 3, computer system 20 is provided for determining a risk of incidence in an elevator device and for determining an inspection interval to mitigate the risk. Computer system 20 preferably includes a module for determining an acceptable risk score 205, a module for determining an inspection interval based on the risk score 210, a module for determining an increase in risk score proportional to a time elapsed since an expected inspection in the inspection interval if the expected inspection has been missed 215, a module for determining a tolerance within the inspection interval based on the increased risk 220, and a module for specifying an inspection interval and an inspection tolerance based on said determined schedule and said determined tolerance 225.

The module for determining an acceptable risk score 210 is programmed to select the maximum of an operational risk score and a device incident risk score to determine the acceptable risk score. The operational risk score is preferably calculated based on observed and/or measured incident occurrences of the people moving device, and the device incident risk score is calculated based on historical failure data. Thus, as will be appreciated in more detail below, both real-time calculated and/or measured risks and historically observed risks are contemplated by the invention. Since historically observed risks, and methods for setting an inspection interval based on these risks are known in the prior art, such methods are not described in additional detail herein. Rather, the invention provides for determining and evaluating risks to set an inspection interval based on an aggregation of operational risks as herein defined.

For the purposes of this application, and based on an observed non-compliance or measured non-compliance by way of sensors positioned on the elevating device, risk is defined as the frequency at which elevator riders may be expected to sustain a given level of injury from the realization of a hazard.

In order to express this risk, the invention defines an operational risk score calculated from equation (1):

RD=fb*D (1)

where fb is the frequency of incident occurrences per year; and, D is a measure of life years expected to be lost as a result of these occurrences by occurrence type. Alternatively, D may be a measure of operating years of the elevator expected to be lost as a result of these occurrences. In calculating D, a combination of short term effects and long term effects has been found to be most effective, to thereby model the life years lost both due to immediate incidents, and those due to long term chronic, or similar incidents.

The variable D is calculated based on equation (2):

D=SW*SD+FL*LW*LD (2)

where: SW is a short-term weight, SD is a short-term duration effect measured in years, FL is a fraction representative of the long-term versus short-term effects, LW is a long-term weight, and LD is a long-term duration effect measured in years. Applicant has identified, and estimated the life years expected to be lost stemming from short and long term effects for various types of injuries, as summarized in Table 1:

TABLE 1

| | | Short-term | | |
|---|---|---|---|---|
| | Short-term | Duration | Fraction | Long-term |
| | weights | (years) | Long-term | weights |
| Injury Type | (SW) | (LD) | effects (FL) | (LW) |
| Aches or pains | 0.02 | 0.0200 | 0.00 | 0.000 |
| Amputation | 0.174 | 0.0000 | 1.00 | 0.174 |
| Bruise hemorrhage | 0.2 | 0.0425 | 0.00 | 0.000 |
| Burns minor | 0.1137 | 0.0827 | 1.00 | 0.001 |
| Burns severe | 0.3622 | 0.2795 | 1.00 | 0.255 |
| Concussion | 0.354 | 0.0671 | 0.05 | 0.350 |
| Dislocation of limb | 0.0744 | 0.0200 | 0.00 | 0.000 |
| Electric shock minor | 0.04 | 0.0200 | 0.00 | 0.000 |
| Electric shock severe | 0.2 | 0.1000 | 0.10 | 0.150 |
| External bruise | 0.04 | 0.0200 | 0.00 | 0.000 |
| Eye injury | 0.3543 | 0.0192 | 0.10 | 0.298 |
| Fatal injury | 1 | 0.0000 | 1.00 | 1.000 |
| Fracture major bone | 0.20564 | 0.1000 | 0.05 | 0.100 |
| Fracture nose or | 0.08835 | 0.0699 | 0.00 | 0.000 |
| Heart attack | 0.323 | 0.1000 | 0.20 | 0.353 |
| Injury leading to | 0.22 | 0.0000 | 1.00 | 0.220 |
| Laceration deep cut | 0.19368 | 0.1000 | 0.00 | 0.000 |
| Laceration superficial | 0.02152 | 0.0200 | 0.00 | 0.000 |
| Nausea dizziness | 0.04 | 0.0200 | 0.00 | 0.000 |
| No injury | | 0.0000 | 0.00 | 0.000 |
| Other internal injury | 0.208 | 0.0425 | 0.00 | 0.000 |
| Poisoning | 0.611 | 0.0082 | 0.00 | 0.000 |
| Respiratory infection | 0.07 | 0.0200 | 0.00 | 0.000 |
| Seizure | 0.15 | 0.1000 | 0.00 | 0.000 |
| Skin infection | 0.07 | 0.0200 | 0.00 | 0.000 |
| Spinal injury | 0.725 | 0.0000 | 1.00 | 0.725 |
| Sprained or twisted | 0.064 | 0.0384 | 0.00 | 0.000 |
| Swelling | 0.04 | 0.0200 | 0.00 | 0.000 |
| Undue exposure to | 0.15 | 0.1000 | 0.00 | 0.000 |
| Whiplash | 0.04 | 0.0200 | 0.05 | 0.04 |

The long term duration variable, LD, in equation (2) represents the expected term of life that would be left if the injury or incident had not occurred. For example, as shown in FIG. 2, different age groups have a different remaining life expectancy:

TABLE 2

Life Expectancy

| Age Group | Male | Female | Average |
|---|---|---|---|
| 0-14 | 73.09 | 76.42 | 74.755 |
| 15-24 | 58.4 | 61.8 | 60.1 |
| 25-44 | 42.7 | 46.17 | 44.435 |
| 45-64 | 22.8 | 26.55 | 24.675 |
| 65+ | 8.54 | 10.38 | 9.46 |

Analogously, this data may be applied to mechanical and/or electrical components in an elevating device, where the injury type could represent a particular type of mechanical and/or electrical incident with corresponding long term and short term durations and weights. An equivalent to table 2 would also be created to identify the remaining life expectancy for particular mechanical and/or electrical components if the incident had not occurred. Such mechanical and/or electrical life expectancies are generally known in the art, however, their application to the description of the invention is thought to be novel. Another way of approaching this issue is to consider the types of injuries that result from various reported elevator incidents. Table 3 shows the results the expected risks to users and their relative severity based on research undertaken by the applicant. Correlating the incident types with the effects on human life as per Table 2 may also be used to determine the values of D in equation (2) and ultimately a risk score from equation (1).

TABLE 3

| | | | Serious | Minor | No |
|---|---|---|---|---|---|
| Occurrence Type | Description | Fatality | Injury | Injury | Injury |
| Alarm bell | this could lead to longer periods of entrapment | 0.05% | 1% | 15% | 84% |
| inoperative | causing physical/mental discomfort | | | | |
| Deficiencies not | will not receive separate likelihood and consequence | 0% | 0% | 0% | 100% |
| directly resulting | directly but will be dealt with through actual | | | | |
| in health impact | observed deficiencies | | | | |
| Door closing | caught between doors | 0% | 5% | 20% | 75% |
| force too high | | | | | |
| (entrapped | | | | | |
| between doors) | | | | | |
| Door closing | struck by doors | 1% | 5% | 34% | 60% |
| speed too high | | | | | |
| Door reopening | struck and/or caught by doors | 0% | 1% | 34% | 65% |
| device inoperative | | | | | |
| Door separation | hall door closing with car door open or vice versa | 0% | 1% | 20% | 79% |
| | could lead trip, falls etc. | | | | |
| Electric shock | could lead to burns, tingling, tickling | 0.05% | 0.95% | 89% | 10% |
| Elevator moving | uncontrolled movement (e.g. drifting) may lead to | 1% | 10% | 30% | 59% |
| with door open | slip, trip or falling into pit, or struck by car header or | | | | |
| | car floor, entrapment | | | | |
| Elevator running | running at rated speed | 5% | 35% | 15% | 45% |
| with door open | | | | | |
| Sudden stop (due | could cause cuts, bruises, physical discomfort etc | 0% | 5% | 20% | 75% |
| to safety buffer) --> | | | | | |
| all device types | | | | | |
| except escalator | | | | | |
| Entrapment | cuts, bruises, shearing, crushing etc. | 10% | 70% | 20% | 0% |
| between hoistway | | | | | |
| and platform | | | | | |
| Entrapment | cuts, bruises, shearing, crushing etc. | 0% | 2% | 90% | 8% |
| between lift and | | | | | |
| surrounding area | | | | | |
| (Unenclosed Vert. | | | | | |
| Plat. Lift) | | | | | |
| Entrapment | cuts, bruises, severence etc | 0.05% | 5% | 80% | 14.95% |
| between step and | | | | | |
| comb plate | | | | | |
| Entrapment | cuts, bruises, severence etc | 0% | 8% | 70% | 22% |
| between step and | | | | | |
| skirt | | | | | |
| Entrapment | cuts, bruises, severence etc | 0% | 1% | 30% | 69% |
| between steps | | | | | |
| Escalator sudden | could cause slips, trips, and falls | 0.05% | 19.95% | 30% | 50% |
| stop | | | | | |
| Exposed hoistway | | 1% | 5% | 3% | 91% |
| Exposed wellway | | 1% | 10% | 4% | 85% |
| Falling object in | doors are open someone walking in is hit by loose | 1% | 5% | 40% | 54% |
| door way | objects | | | | |
| Falling object in | could cause cuts, bruises, physical discomfort etc | 0% | 1% | 2% | 97% |
| path of lift | | | | | |
| Falling object on | rider hit by falling objects | 1% | 5% | 40% | 54% |
| beltway (manlift) | | | | | |
| Falling objects in | cuts, bruises, head injuries, severence etc. | 0% | 1% | 40% | 59% |
| the car | | | | | |
| Fire elevator | burns, smoke inhalation | 1% | 2% | 30% | 67% |
| Fire escalator | burns, smoke inhalation | 0% | 1% | 5% | 94% |
| Fire manlift | burns, smoke inhalation | 1% | 1% | 20% | 78% |
| Fire construction | burns, smoke inhalation | 1% | 1% | 20% | 78% |
| hoist | | | | | |
| Fire unenclosed | burns, smoke inhalation | 0% | 1% | 5% | 94% |
| vert. Plat. Lift | | | | | |
| General | will not receive separate likelihood and consequence | 0% | 0% | 0% | 100% |
| regulatory | directly but will be dealt with through actual | | | | |
| requirements | observed deficiencies | | | | |
| Hazards to | these could result when public do not have access but | 0.05% | 9.95% | 40% | 50% |
| inspector/mechanic | mechanic or inspector may be exposed | | | | |
| Hoist moving | uncontrolled movement (e.g. drifting) may lead to | 0.05% | 9.95% | 20% | 70% |
| with door open | slip, trip or falling into pit, or struck by car header or | | | | |
| | car floor, entrapment | | | | |
| Hoist running | running at rated speed | 1% | 25% | 10% | 64% |
| with door open | | | | | |
| Hoist striking | could result in serious injuries or fatality | 0.05% | 9.95% | 30% | 60% |
| building parts or | | | | | |
| other object | | | | | |
| Improper handrail | could cause falls | 0% | 0% | 5% | 95% |
| speed | | | | | |
| Inadequate | cuts, bruises, and head injuries | 0% | 4% | 6% | 90% |
| lighting | | | | | |
| Lift sudden stop | could cause cuts, bruises, physical discomfort etc | 0% | 0% | 0% | 100% |
| (Unenclosed | | | | | |
| Vertical Platform | | | | | |
| Lift) | | | | | |
| Out of level | could lead to trip or fall | 0% | 5% | 20% | 75% |
| Overspeed ascent | cuts, bruises, head injuries, etc. | 0.05% | 24.95% | 60% | 15% |
| Overspeed | cuts, bruises, head injuries, etc. | 0.05% | 24.95% | 60% | 15% |
| descent | | | | | |
| Part falling off | could result in serious injuries or fatality | 1% | 10% | 30% | 59% |
| hoist | | | | | |
| Rider did not | could cause cuts, bruises, physical discomfort etc | 0% | 0% | 1% | 99% |
| disembark at | | | | | |
| terminal landing | | | | | |
| (Manlift) | | | | | |
| Rider falling off | could lead to serious injury or fatality | 1% | 30% | 40% | 29% |
| belt | | | | | |
| Rider struck | could cause cuts, bruises, physical discomfort etc | 0% | 5% | 25% | 70% |
| object at floor | | | | | |
| opening (Manlift) | | | | | |
| Sharp edges | could lead to cuts, bruises, severence etc. | 0% | 5% | 90% | 5% |
| Shearing/pinching | finger caught b/w door jam; | 0% | 0% | 90% | 10% |
| | finger caught in gate or b/w gate and post; | | | | |
| | finger caught in equipment | | | | |
| Two way | this could lead to longer periods of entrapment | 0.05% | 1% | 15% | 84% |
| communication | causing physical/mental discomfort | | | | |
| inoperative | | | | | |

The examples, and data discussed and shown with respect to the tables above are not to be considered all-encompassing or limiting on the invention, and are merely illustrative to allow a person skilled in the art to put the invention into practice. Rather, the invention discloses a method and system that may use the data presented in the tables above as inputs in the preferred embodiments, but the method and system of the invention are not restricted or limited to the use of such data.

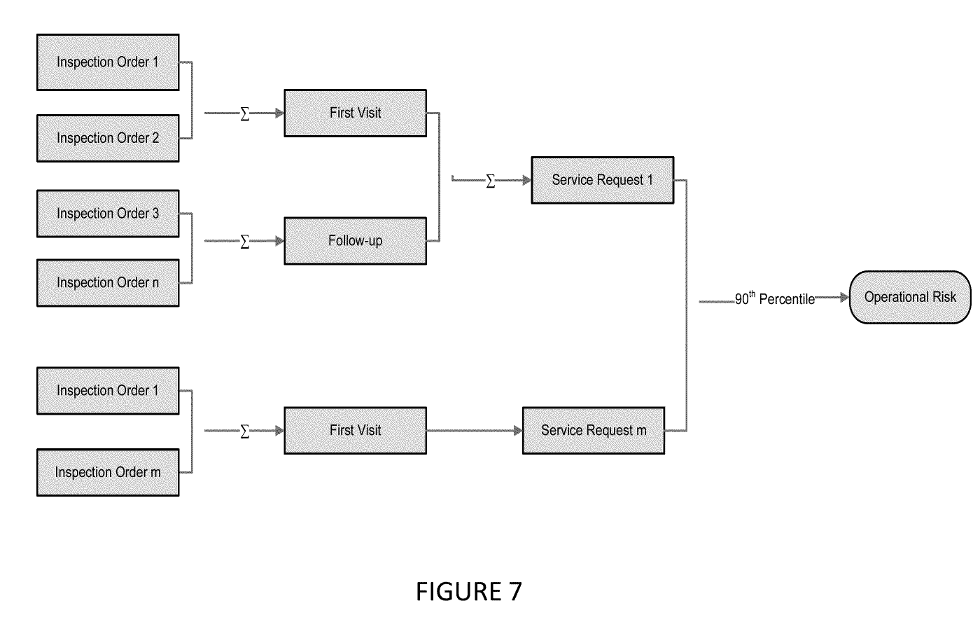

Each type of incident will be accumulate risk, and in this manner, the invention also distinguishes over prior art system and methods which treated each of type of potential risk independently of each other one with regards to maintenance and inspections. Accordingly, the module for determining an acceptable risk score 210 preferably also calculates an overall operational device risk score as the summation of each incident risk score as determined from equation (1). As shown in FIG. 7, according to a preferred embodiment, and in situations where there are a large number of incidents accumulating risk, the invention considers the use of only aggregating the 90^{th} percentile of risks towards the operational device risk score. In this manner, incidents that contribute relative small amounts (ie. the 10^{th} percentile of scores) to the aggregate risk score are not included in the calculation. This allows for a large number of inspection orders to be carried out, and incidents documented without concern that truly insignificant incidents will be recorded and applied in aggregate to a device operational risk score.

The invention thus provides the ability to trigger an inspection or maintenance call when there are sufficient numbers of risks that when taken independently of each other would seem insignificant. Furthermore, the elevator device may thus be classified as either high risk device, a medium risk device, or a low risk device based on the aggregate operational risk score. Scheduling of inspections may then be accomplished so that elevators with a higher number of incidents, irrespective of their severity, or elevators with fewer but more severe incidents may have inspections scheduled with a higher urgency. Thus, the invention captures such aggregate risks that have heretofore been ignored, or otherwise fallen below the radar, in prior art methods and systems.

According to one example, if an elevator device is characterized as a high risk device, it is immediately identified for an inspection, or alternatively, for a maintenance order. Elevating devices characterized as high risk devices are, beyond this point, not treated according to the invention, as they are immediately subjected to an inspection order. It is generally accepted in the art that if there is an expectation of one fatality over a 6-month operational period, then an elevator is considered a high risk elevator and should be inspected immediately for hazardous risks.

Using the one fatality over a 6-month period as a basis, equation (2) can be solved to result in a value of 4.5×10⁴. Accordingly, where a value of D is obtained greater than this figure, the elevator is characterized as a high risk elevator and is immediately scheduled for inspection. If the expected fatality risk is less than on fatality over a 6 month period and equal to or greater than serious injury over a 12 month period then the elevator can be characterized a medium risk device. This is one where the value of D from equation (2) is between 4.5×10⁻⁴ and 6.7×10⁻⁶. A low risk elevator in when there is an expectation of injury is less than one serious injury over a 12 month period but greater than a minor injury over an 18 month operational period. Low risk elevators will result in a value of D from equation (2) of between 6.7×10⁻⁶ and 4.71×10⁻⁹. Values of D lower than 4.71×10⁻⁹ are considered safe—that is, there is an expectation of injury of less than one minor injury over an 18 month operational period. These elevators may be inspected according to prior art methods, or on a schedule dictated by a regulating body. The invention focuses on those elevators identified as medium and low risk elevators, and the scheduling of inspections and/or maintenance with respect thereto. High risk elevators may be identified according to the method and system described herein, but a high risk indication requires immediate action and therefore will not benefit from the scheduling capabilities of the invention as described below. Similarly, low risk elevators have no, or only negligible, identified risks and accordingly cannot be modeled in accordance with the teachings of the invention.

Next, the system according to the invention, includes the module for determining an inspection interval 210 calculates an inspection interval having inputs into the calculation stemming from the risk score as described above. Applicants have discovered that the inspection interval is best modeled separately for medium and low risk devices, since each is defined in terms of the number of injuries expected per different time units.

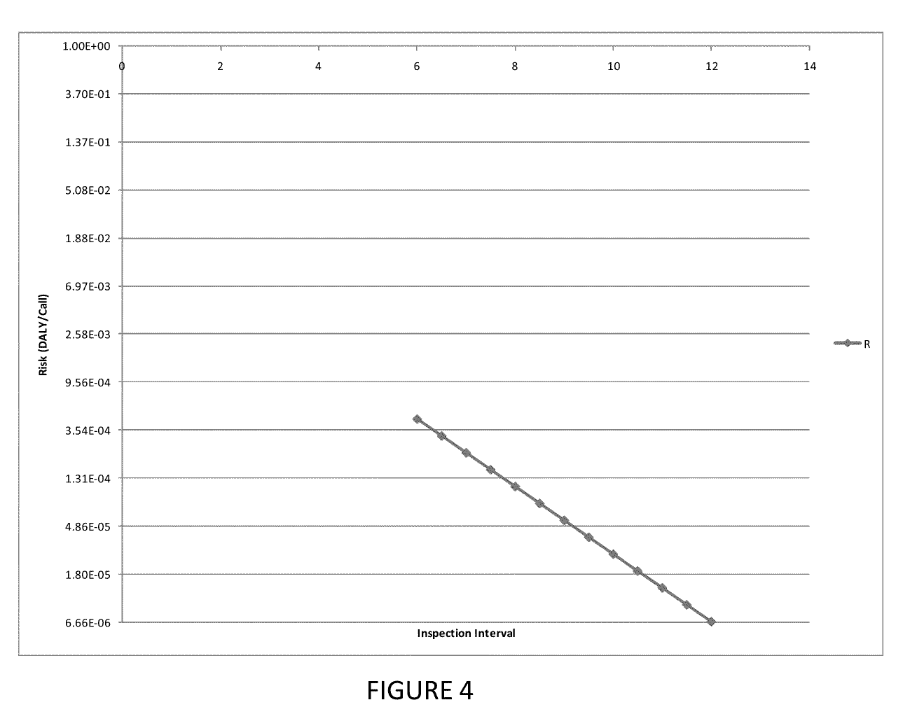

Let's start with the development of a functional equation that governs the medium risk devices. In this regime the inspection interval range from 6 to 12 months. For a monotonically decreasing inspection interval a monotonically increasing risk value is modeled by using the exponential function. In the face of model uncertainty, the scientific selection of the mathematical function is based on the fact that; it fulfills the requirements of the boundary conditions and ranks the elevating devices coherently, and achieves the safety goals in a consistent manner. The function is a good fit for the risk score distribution, as shown in FIG. 4. Equation (3) shows this function for medium risk devices:

R_{M}=6.7×10⁻⁶exp[0.7(12−t_{M})] (3)

where t_{M}ε[6,12]months

Accordingly, for known operational risk scores as calculated above, the inspection interval in months is shown in equation (4):

$${t}_{M} = 12 - \frac{1}{0.7} LN [ \frac{{R}_{M}}{6.7 \times {10}^{- 6}} ] \qquad ( 4 )$$

where R_{M}ε[4.5×10⁻⁴,6.7×10⁻⁹]D/call

Similarly, the governing equation for low risk devices is shown in equation (5):

R_{L}=4.713×10⁻⁹exp[1.21(18−t_{L})] (5)

where t_{L}ε[12,18]months

Accordingly, for known operational risk scores as calculated above, the inspection interval in months for low risk devices is shown in equation (6):

$${t}_{L} = 18 - \frac{1}{1.21} LN [ \frac{{R}_{L}}{4.713 \times {10}^{- 9}} ] \qquad ( 6 )$$

where R_{L}ε[6.7×10,4.713×10⁻⁹]D/call.

Once an inspection interval has been determined, the module for determining an increase in risk score calculates an increased risk score R_{M} or R_{L}, respectively for medium and low risk devices. The invention provides that if a device has missed its inspection date then it starts accumulating real-time operational risk. Equations (3) to (6) are not capable of modeling the incremental risk values due to elapsed time since the last missed inspection date. Whence a device does not get inspected on or before the due inspection date, then its predicted risk increases with the elapsed time since the missed inspection date. The challenge is: how to model this? One way of doing it is that a person thinks of an imaginary source that start contributing to the risk when a device is not inspected on its due date. This imaginary source is introduced through a simple reflection scheme. This can be best described by the following example:

Assuming a device was on the 8-month inspection cycle (in this example, the calculated value of 8 months is derived from equation 4 for a calculated operational risk of 1.1×10⁻⁴), and the device is not inspected till the 9^{th} month (i.e. overdue inspection time is one month). Assuming the overdue month has contributed the amount of risk ΔR_{S}, then the total risk for a device at any overdue inspection time, R_{S+od*}, is

R_{S+od*}=ΔR_{S}+R_{S}=R_{S-od}

where, R_{S} is operational risk corresponding to the scheduled inspection interval; and R_{S-od} is operational risk corresponding to the time interval which is a difference between the scheduled interval and the overdue interval (in this example it is operational risk corresponding to: 8−1=7 months).

In the given example, Equation (7) can be written as:

R_{8+1*}=R₈₋₁

or

R_{8+1*}=R₇

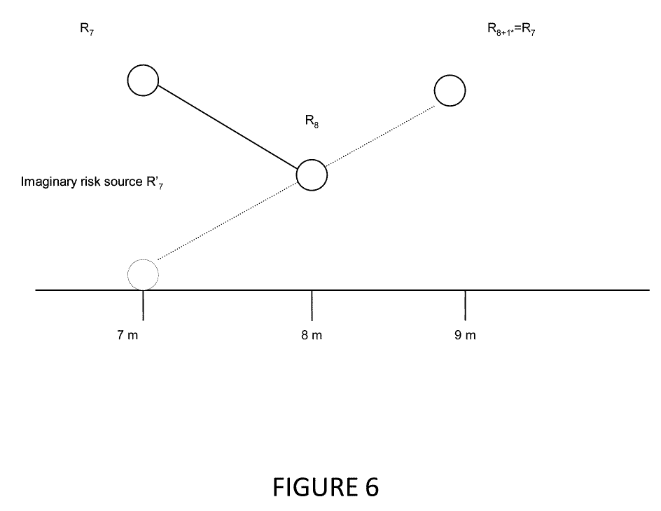

This formation holds if we accept a perfect reflection of risk by placing an imaginary mirror at the due inspection time (i.e., 100% reflection, see FIG. 6).

Based on this discussion Equation 3 can be revised as:

R_{M}=6.7×10⁻⁶exp[0.7(12−(t_{M}−od))] (7)

Where od=overdue inspection time (in the above example it is 9−=1 month).

Due to this reflection scheme we can say that risk starts accumulating once an elevator past its inspection due date and risk accumulates to a point that it reaches to a max tolerability. At this point we can say a device is in “backlog” or potentially poses a higher risk. The risk value of 4.5×10⁻⁴ Ds/Call is used as a tolerability limit. By using this information and Equation 7, a generalized tolerability equation for the Medium risk regime can be given as:

12−[t_{M}−od]≦6 (8)

By considering the strict equality in the above equation we can define the max tolerable od_{T}_{ₘₐₓ} time for the inspection interval t_{M}ε[6,12]months as

od_{T}_{ₘₐₓ}=t_{M}−6 (9)

This relationship is shown graphically in FIG. 4. The relationship between the max tolerable overdue time and inspection interval is linearly proportional: the higher the inspection interval the more tolerability in terms of overdue time period.

Similarly, for low risk devices:

18−[t_{L}−od]≦12

By using the equality sign in the above equation we can define the od_{T}_{ₘₐₓ} for the inspection interval t_{L}ε[12,18]months as

od_{T}_{ₘₐₓ}=t_{L}−6 (10)

Assuming t_{L}=18, as an example, then Equation (10) says that the max tolerable overdue time is 12 months. This means that under the assumption of this reflection scheme if a device with 18 months inspection interval goes uninspected for another 12 months then at the 30^{th} month the device will be having a risk score corresponding to 4.5×10⁻⁴ Ds/Call.

Now for the safe bin devices there is another constraint which requires the inspection of a device at least once in 36 months regardless its risk score approaches to zero. The minimum operator is used to quantify the od_{T}_{ₘₐₓ} by using the following two Equations:

Min[od_{T}_{ₘₐₓ}=t_{S}−6,od_{T}_{ₘₐₓ}=36−t_{S}] (11)

At tₛ=21 months both equations give the same value of od_{T}_{ₘₐₓ}=15. Before this break even inspection interval of 21 months, the reflection scheme governs, and after it, the constraint related to 1 inspection in 36 months governs the od_{T}_{ₘₐₓ} value for the safe regime.

Accordingly, it can be seen that the invention provides for a tolerance within which inspections are to occur and provides a technical, computer-implemented and quantitative solution to a long felt need in the art. Applicant submits that applicant's system provides a novel approach to evaluating risk in elevating devices, for determining real-time aggregate operational risk as described, and for initiating inspections and/or maintenance based on the quantified risk. Furthermore, it is contemplated that inputs into the equations above may be derived directly from measurement devices or sensors position on mechanical components of the elevating devices. Certain examples of putting the invention into practice are provided further below. From the system described above, a detailed inspection and/or maintenance schedule may be determined that includes adaptations for missed or late inspections that have heretofore not been available in the prior art.

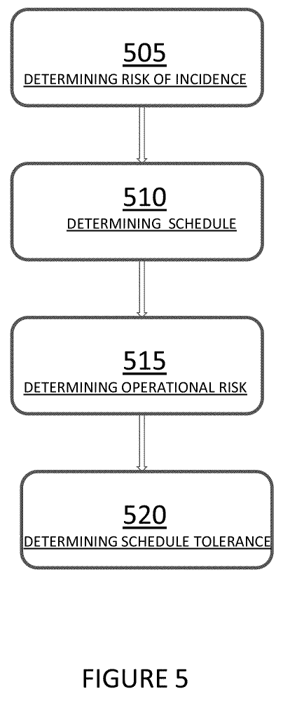

According to other embodiments of the invention, and with reference to FIG. 5, the invention includes a method for determining a risk of failure in a people moving device and for determining an inspection interval to mitigate said risk. The method preferably includes the steps of determining an acceptable risk score 505, determining an inspection interval based on the risk score 510, determining an increase in risk score proportional to a time elapsed since an expected inspection in the inspection interval if the expected inspection has been missed 515, determining a tolerance within the inspection interval based on the increased risk 520, and specifying an inspection interval and an inspection tolerance based on the determined schedule and the determined tolerance. The method herein described may be implemented with the system described above.

The method may further include the step of determining an acceptable risk score 525 by selecting the maximum of an operational risk score, and a device incident risk score. Preferably, the operational risk score is calculated based on observed and/or measured incident occurrences of the people moving device, and the device incident risk score is calculated based on historical failure data. That is, where historical incident data exists, it will be the overriding factor in determining a high risk device.

The calculation of risk scores, and the associated scheduling of inspections and/or maintenance along with the calculation and adaptation of tolerances on the scheduling of inspections and/or maintenance is carried out in accordance with the teachings of the system described above.

According to yet another embodiment of the invention, applicants contemplate an elevator device for a building having an associated computer system in communication therewith for carrying out various aspects of the invention as described above. According to this embodiment, the elevator itself, or mechanical/electrical components associated therewith may be provided with sensors or other measuring means that communicate information regarding the expected remaining life of various components to the computer system described above. Accordingly, an inspection and/or maintenance schedule may be provided in response to information derived from these sensors or other measuring means and having been processed by the system of the invention as herein described.

### Example 1

An elevator having been inspected following different incident reports in the previous three years relating to each of (1) the elevator stopping between floors and (2) a failure of the sensors that ensure that doors do not close when users are in the doorway. It is known that these two incidents pose a risk of (1) a sprained ankle from a user tripping upon exiting the elevator when the elevator does not stop at an appropriate level with respect to the floor, and (2) a risk of aches or pains caused by the door closing on a user. Furthermore, since the elevator is in a university building housing students between the ages of 15-24, it is known from Table 2 that the average life expectancy of the user's of the elevator from their current age is 60.1 years.

Accordingly, from equation (2) above and with reference to Tables (1) and (2), a calculation of the number of life years expected to be lost as a result of each of these occurrences as:

| D(1) | D(2) |
|---|---|
| .0025 | .0004 |

This leads to a calculation of an operational risk score, from equation (1), based on 1 incidence every three years, and summed up for each of D(1) and D(2) of R=0.00097. These results in the classification of the elevator device as a medium risk elevator.

Accordingly, from equation (4) above, the inspection interval in months is determined to be 4.9 months.

Assuming the inspection date is missed, and the 6 month date from a previous inspection arrives, the inspection is now 1.1 months overdue, and 1.1 months worth of additional risk has been accumulated. A new risk score at the 6 month date can be calculated from equation (7), and so long as the score does not enter the range of a high risk device, the delayed inspection is still within the acceptable tolerance.

### Example 2

An elevator has been inspected following alert notices automatically generated by sensors adapted to report on the structural integrity of the cables used to move the elevator between floors. The cables used in the elevator have an expected life span of 150 years under normal operation, however, due to excessive debris in the elevator shaft coming into contact with the cables, a weakening point has been sensed. It is determined that for such cables, from equation (2), the value of SW is 0.0048, SD is 0.0069, FL is 0.0009 and LW is 0.0030. The remaining life of the cables, LD is 12 years.

Accordingly, from equation (2), the value of D is calculated to be 6.6×10⁻⁵. This leads to a calculation of an operational risk score, from equation (1), based on 1 incident this year of R=6.6×10⁻⁵. These results in the classification of the elevator device as a medium risk elevator.

Accordingly, from equation (4) above, the inspection interval in months is determined to be 8.7 months.

Assuming the inspection date is missed, and the 10 month date from a previous inspection arrives, the inspection is now 1.3 months overdue, and 1.3 months worth of additional risk has been accumulated. A new risk score at the 10 month date is calculated from equation (7) as, and so long as the score does not enter the range of a high risk device, the delayed inspection is still within the acceptable tolerance.

The above-described embodiments are intended to be examples of the present invention and alterations and modifications may be effected thereto, by those of skill in the art, without departing from the scope of the invention that is defined solely by the claims appended hereto. While the invention has been described with respect to elevators and similar people moving devices, for clarity, applicant notes that elevating and similar people moving devices include devices capable of moving groups of people in public places that are subject to the periodic maintenance and inspection regimes described above. Elevator and similar people moving devices include, but are not limited to, elevators, escalators, horizontal people movers, amusement park rides such a rollercoaster, and ramp-type lifts for wheelchair users.

Fuel Storage Facilities, Equipment and Devices

In another implementation of the concepts of the invention, the method and system described above may be adapted for application to fuel storage facilities and equipment for commercial, industrial and/or residential use where mandated inspections are requirement by regulatory authorities. The description below address those aspects of the method and system that may differ in implementation with respect to fuel storage facilities, equipment and devices, and unless otherwise noted, the principles described above with respect to people moving devices are equally applicable here.

Fuel storage facilities and equipment for the dispensing of fuels included an added dimension in that the proposed method and system for operational risk quantification involves the characterization of, for example, frequency associated with an occurrence type (mechanism by which hazard would be realized) given non-compliance, human exposure estimated based on population density in the vicinity of the facility, mechanical failures, and consequences based on the type and capacity of material stored and the types of occurrences. That is, the major distinction and added variables are the estimated population density in the vicinity of the facility and the types of and capacity of the material stored.

For the purposes of this application, and based on an observed non-compliance or measured non-compliance by way of sensors positioned at the facility, risk is defined as the frequency at which public in the vicinity of a facility is expected to sustain a given level of injury from the realization of a hazard,

In order to express this risk, the invention defines an operational risk score calculated from equation (1):

RD=fb*D (1)

where fb is the frequency of incident occurrences per year; and, D is a measure of life years expected to be lost as a result of these occurrences by occurrence type. Alternatively, D may be a measure of operating years of the device expected to be lost as a result of these occurrences. In calculating D, a combination of short term effects and long term effects has been found to be most effective, to thereby model the life years lost both due to immediate incidents, and those due to long term chronic, or similar incidents.

The variable D is calculated based on equation (2):

D=SW*SD+FL*LW*LD (2)

where: SW is a short-term weight, SD is a short-term duration effect measured in years, FL is a fraction representative of the long-term versus short-term effects, LW is a long-term weight, and LD is a long-term duration effect measured in years. Applicant has identified, and estimated the life years expected to be lost stemming from short and long term effects for various types of injuries, as summarized in Table 4:

TABLE 4

| | | | | |
|---|---|---|---|---|
| Aches or pains | 0.02 | 0.0200 | 0.00 | 0.000 |
| Amputation | 0.174 | 0.0000 | 1.00 | 0.174 |
| Bruise hemorrhage | 0.2 | 0.0425 | 0.00 | 0.000 |
| Burns minor | 0.1137 | 0.0827 | 1.00 | 0.001 |
| Burns severe | 0.3622 | 0.2795 | 1.00 | 0.255 |
| Concussion | 0.354 | 0.0671 | 0.05 | 0.350 |
| Dislocation of limb | 0.0744 | 0.0200 | 0.00 | 0.000 |
| Electric shock minor | 0.04 | 0.0200 | 0.00 | 0.000 |
| Electric shock severe | 0.2 | 0.1000 | 0.10 | 0.150 |
| External bruise | 0.04 | 0.0200 | 0.00 | 0.000 |
| Eye injury | 0.3543 | 0.0192 | 0.10 | 0.298 |
| Fatal injury | 1 | 0.0000 | 1.00 | 1.000 |
| Fracture major bone | 0.20564 | 0.1000 | 0.05 | 0.100 |
| Fracture nose or fingers | 0.08835 | 0.0699 | 0.00 | 0.000 |
| Heart attack | 0.323 | 0.1000 | 0.20 | 0.353 |
| Injury leading to deafness | 0.22 | 0.0000 | 1.00 | 0.220 |
| Laceration deep cut | 0.19368 | 0.1000 | 0.00 | 0.000 |
| Laceration superficial | 0.02152 | 0.0200 | 0.00 | 0.000 |
| Nausea dizziness | 0.04 | 0.0200 | 0.00 | 0.000 |
| No injury | | 0.0000 | 0.00 | 0.000 |
| Other internal injury | 0.208 | 0.0425 | 0.00 | 0.000 |
| Poisoning | 0.611 | 0.0082 | 0.00 | 0.000 |
| Respiratory infection | 0.07 | 0.0200 | 0.00 | 0.000 |
| Seizure | 0.15 | 0.1000 | 0.00 | 0.000 |
| Skin infection | 0.07 | 0.0200 | 0.00 | 0.000 |
| Spinal injury | 0.725 | 0.0000 | 1.00 | 0.725 |
| Sprained or twisted | 0.064 | 0.0384 | 0.00 | 0.000 |
| Swelling | 0.04 | 0.0200 | 0.00 | 0.000 |
| Undue exposure to | 0.15 | 0.1000 | 0.00 | 0.000 |
| Whiplash | 0.04 | 0.0200 | 0.05 | 0.04 |

The long term duration variable, LD, in equation (2) represents the expected term of life that would be left if the injury or incident had not occurred. For example, as shown in FIG. 2, different age groups have a different remaining life expectancy:

TABLE 5

Life Expectancy

| Age Group | Male | Female | Average |
|---|---|---|---|
| 0-14 | 73.09 | 76.42 | 74.755 |
| 15-24 | 58.4 | 61.8 | 60.1 |
| 25-44 | 42.7 | 46.17 | 44.435 |
| 45-64 | 22.8 | 26.55 | 24.675 |
| 65+ | 8.54 | 10.38 | 9.46 |

An equivalent to table 5 would also be created to identify the remaining life expectancy for the components if the incident had not occurred. Such expectancies are generally known in the art, however, their application to the description of the invention is thought to be novel. Another way of approaching this issue is to consider the types of injuries that result from various reported facility incidents. Table 6 shows the results the expected risks to users and their relative severity based on research undertaken by the applicant. Correlating the incident types with the effects on human life as per Table 5 may also be used to determine the values of D in equation (2) and ultimately a risk score from equation (1).

TABLE 6

| Occurrence Type | DALY | Injury Types |
|---|---|---|
| No Consequence | 0.00 | |
| Fire | 9.25 | Fatality, Burns, Carcinomatous Poison, |
| | | External bruise, Laceration, Nausea, Skin |
| | | infection, Respiratory infection, Aches |
| Vapor Release | 4.99 | Burns, Nausea, Bruise, Laceration |
| Explosion | 11.66 | Fatality, Burns, Carcinomatous Poison, |
| | | External bruise, Laceration, Nausea, Skin |
| | | infection, Respiratory infection, Heart |
| | | attack, Aches, Concussion, Fracture |
| CO Release | 3.43 | Fatality, Carcinomatous Poison, Nausea |

The examples, and data discussed and shown with respect to the tables above are not to be considered all-encompassing or limiting on the invention, and are merely illustrative to allow a person skilled in the art to put the invention into practice. Rather, the invention discloses a method and system that may use the data presented in the tables above as inputs in the preferred embodiments, but the method and system of the invention are not restricted or limited to the use of such data.

Each type of incident will accumulate risk, and in this manner, the invention also distinguishes over prior art system and methods which treated each of type of potential risk independently of each other one with regards to maintenance and inspections. Accordingly, the module for determining an acceptable risk score 210 preferably also calculates an overall 1 facility risk score as the summation of each incident risk score as determined from equation (1).

Another application of the invention is its suitability in the risk-based inspection scheduling of fuel storage and dispensing equipment. A variation from the facility application described above, is the number of people exposed to the risk of a fire, explosion, vapor release or carbon-monoxide release.

A hazard radius is a determined radius based on the maximum capacity of a fuel storage tank at a facility and the fuel's thermo-dynamic properties. The susceptible number of people exposed is then determined based on population density around the facility.

An initiating event along with a combination of intermediate events could lead to potential hazardous consequences. A deficiency identified at a facility could potentially lead to one of many possible initiating events. The convention is to issue a standard maintenance order by the inspector.

The initiating event frequencies λᵢ are summed in order to obtain the initiating event frequency λ

The severity of the consequence of each of the initiating events is quantified as the frequency, severity and victim weighted DALY per failure scenario for the population in the exposed zone:

$$S = {\sum }_{i} {ω}_{i} {S}_{i} {n}_{i} Daley \text{/} occurence$$

### Where

wᵢ=λᵢ/λ
nᵢ is the number of persons with in a hazard radius.
Sᵢ is the DALY per (person per event) for initiating event i.

The individual risk score of the facility for a single inspection is then determined as the product Sλ of severity and frequency.

Therefore, it will be understood that operational risk scores are determined in different ways for each of the various embodiments as herein described, but the scheduling mechanism, module and method for determining an inspection interval is the same.

### Variation in Projecting Risk

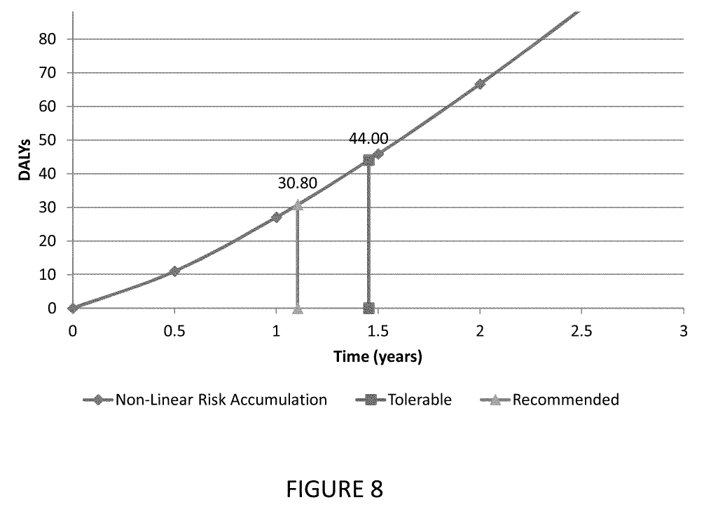

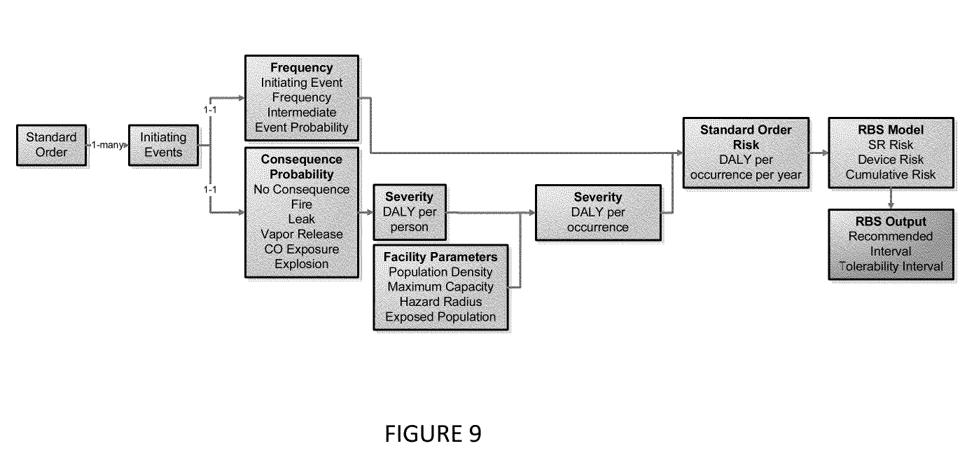

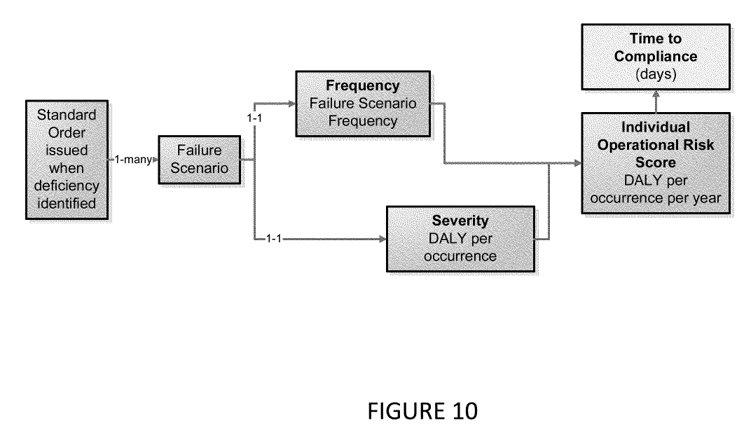

According to one variation, the method includes projecting the risk of fatality in the form of a non-linear curve constructed from historical non-compliance data and time between subsequent inspections. Typically, a forecasted time of fatality (44 DALY) is set as a tolerability interval and a certain percentage of the fatality (representing a permanent injury) is chosen as the recommended interval as shown in the FIG. 8. The assumption is that risk of failure is brought down to zero immediately after an inspection and gradually continues to grow if left unattended.

The above described embodiment is achieved by determining a facility risk score λ_{d} as a weighted-average of individual operational risk scores SRRᵢ determined above and duration Dᵢ between inspections:

$${λ}_{d} = \frac{{\sum }_{i} {SRR}_{i} * {D}_{i}}{{\sum }_{i} {D}_{i}} Daly \text{/} year$$

### Where

λ_{d} is the time-averaged risk expressed in terms of DALYs per year for facility d
λ_{d} is termed as the facility risk score
SRRᵢ is the ith operational risk score for the facility d (referred to as RD in equation (1))
Dᵢ is the time duration in years between inspection dates corresponding to SRRᵢ₋₁ and SRRᵢ.

This equation, incorporates the summation of operational risk scores for a facility and time between inspections dates to determine a risk score. The benefit of this approach versus the approach mentioned earlier in this description is the elimination of a need to select the maximum of two risk scores, as these are now integrated into one calculation.

The time duration between initial inspection and the first periodic inspection is considered as D₁. If required, D₁ is assumed to be 3 years in cases where initial inspection information is unavailable.

The cumulative time-dependent risk curve based on a facility's time-averaged risk λ_{d} and the shape parameter p is given by:

R_{d}(t)=(λt)^{p}DDALY

### Where

R_{d}(t) is the cumulative risk up to time t for facility d.
λ=λ_{d}/D is the occurrence rate expressed as occurrences per year.
D: DALY per occurrence is a constant representing average health impact observed in any given year.
t is the time since the last inspection.
p is the shape factor independent of the facility, determined by fitting a statistical distribution to a dataset containing time to first occurrence signifying underlying failure since the last periodic inspection.

The time to a percentage q of a fatality-equivalent (44 DALY) is given by:

$$T ( q ) = {\frac{1}{λ} [ \frac{( q * 44 )}{D} ]}^{1 / p} Years$$

The lower end of the recommended interval is the last inspection date. The time T₁ to attaining 70% of a fatality-equivalent is considered as upper end of the recommended interval given by T(0.70).

As a guideline, the percentage q could be set to between 70% and 90%; however this could be viewed as flexibility offered by the model to add an operational constraint on the number of facilities that need to be inspected in a year. For example, reducing the percentage would allow more facilities to be inspected in the high risk bin.

The rest of the time to attain a 100% of fatality-equivalent is considered as the tolerability interval:

T₂=T(1)−T(0.70)years

It is desirable to express T₂ in months as T₂*12. In summary, if the last inspection was on date D, then the recommended interval is (D, D+T₁) and tolerable interval is (D+T₁, D+T₁+T₂).

The results of the above analysis and method are shown in FIG. 8.

Time-to-Comply

The various embodiments of the invention as described above disclose, inter alia, methods and system for determining an inspection interval. In some instances, following the determination of an inspection interval, and subsequent carrying out of an inspection order, a particular work order will be issued by an inspector. The work order is typically issued in order to address a determination made during the inspection that a certain action is required to address a deficiency identified during the inspection. A more enhanced assessment of the operational risk score as described above is now described, where the method and system further determines an increase in the operational risk score following the issuance of a work order, as time elapses before the deficiency identified during the inspection is actually rectified.

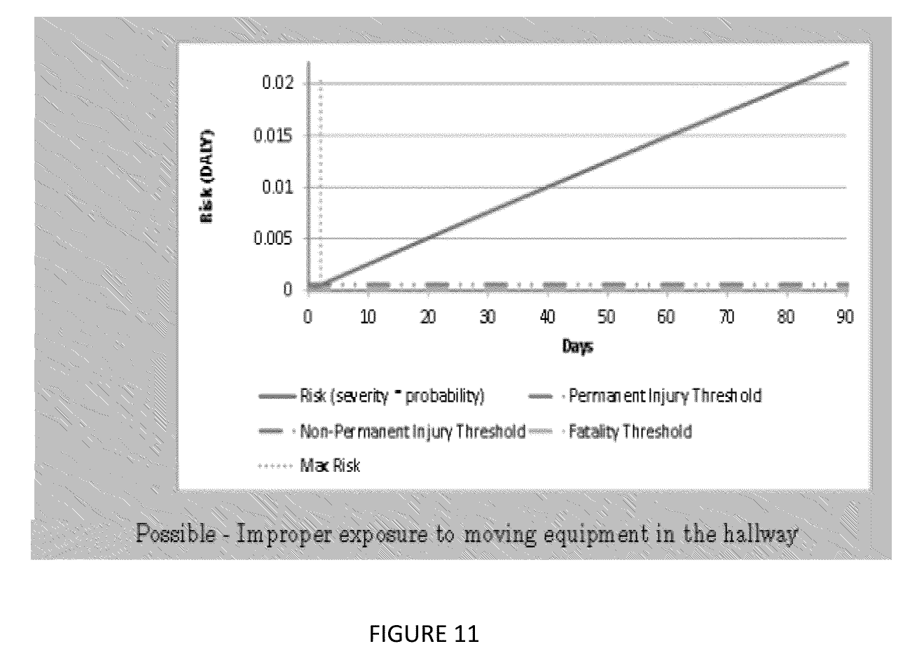

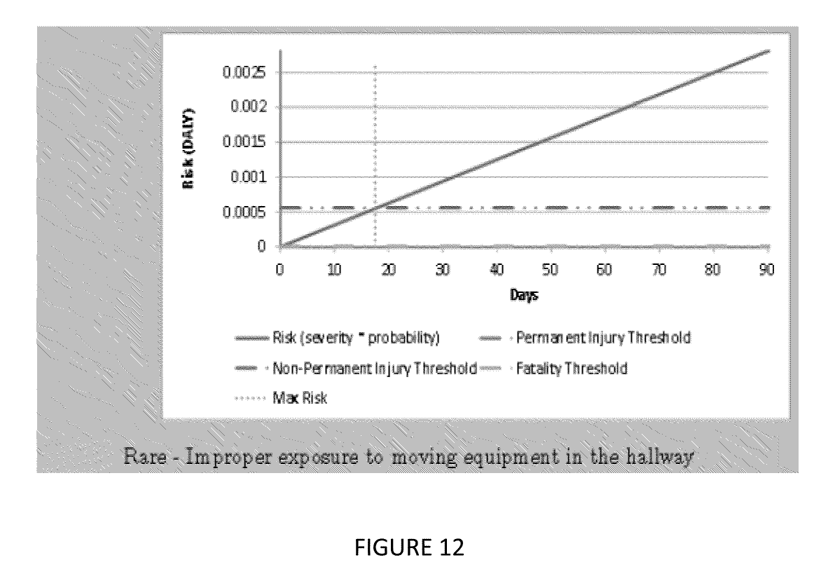

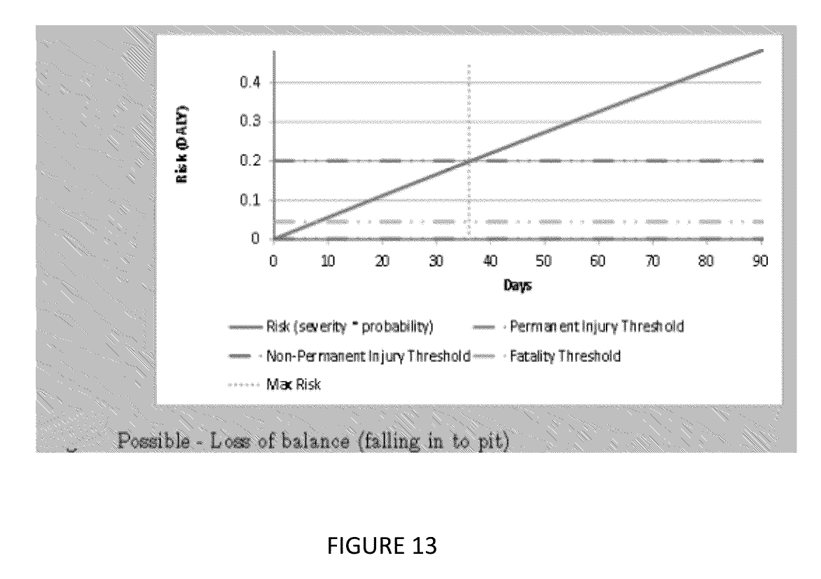

The technique to determine time-to-compliance is a three step process. In the first step, likelihood and severity of each occurrence type for a given nonconformance or deficiency is determined so as to estimate a time varying risk profile of each occurrence type. This step is illustrated in FIG. 11. The label building type is exemplary of the application to elevating devices, but could alternatively refer to any set of technical system specific parameters used to evaluate the frequency of a given occurrence type.

In the second step, a risk threshold is determined for each occurrence type so as to analyze the time at which the occurrence type intersects the threshold. Given the time of possible occurrence of each occurrence type posing maximum risk.

The third step includes determining the time-to-compliance by choosing the time that corresponds to an occurrence type that could potentially occur at the earliest time. The description that follows makes reference to a technical system consisting of elevating devices, but one skilled in the art will appreciate that applications to other technologies may also be implemented.

With reference to FIG. 11, the time-dependent risk estimate of an occurrence type j given a clause k with the frequency fᵢₖⱼ and severity Sₖⱼ (as outlined further below), respectively assuming an exponential profile F(.) is determined as:

$$\begin{matrix}{R}_{kj} ( t ) = {S}_{kj} {F}_{kj} ( t \vert {λ}_{kj} ) \\ = {S}_{kj} [ 1 - {e}^{- {λ}_{kj} t} ]\end{matrix} \qquad ( 1 )$$

Each of the n occurrence types of the clause k has a different maximum threshold Mⱼ and meets the time-dependent risk curve Rₖⱼ(t) at a different time. The decision criteria to choose the time-to-compliance is considered as the time at which an occurrence type hits its respective maximum threshold earlier than any other possible occurrence type for the given clause. This is obtained by determining t from Equation 1 after substituting Mj:

$${T}_{k} = {min}_{j} \{ - \frac{1}{{λ}_{kj}} ln [ 1 - \frac{{M}_{j}}{{S}_{kj}} ] \} , \\ j = 1 , 2 , … , n , \frac{{M}_{j}}{{S}_{kj}} < 1 \qquad ( 2 )$$

There is a possibility that the risk curve in Equation 1 plateaus after a certain time never reaching any of the thresholds leading to Mⱼ/Sₖⱼ>1 and therefore the argument of the ln function in Equation 2 becomes invalid. In this case, the time-to compliance for the occurrence type that violates the rule is set to 91 days, for example, for the minimum operator to function normally. The rationale behind choosing 91 days is based on the assumption that a mandatory operational decision to address a deficiency within 90 days is always applicable. Hence, the time-to-compliance for any inspection order that results in a Tₖ>90 is reset to 90 days. Effectively, the method seeks to determine the maximum risk each occurrence type could potentially pose and then decides on the time that best represents the minimum time-to-compliance.

In one example, there are about 280 types of typical non-conformances or deficiencies that could be found during a typical elevator devices inspection that had the potential to cause occurrences if left unattended. Each of these non-conformances corresponds to a set of n occurrence types, say j=1; 2, . . . , n. An example of a standard order is “pit stop additional required”. This order enforces the elevator device operator to provide an additional stop switch adjacent to the pit ladder and at a certain height above the pit floor. The absence of this switch could potentially cause a technician to be improperly exposed to a moving car in the elevator hoist-way. The consequences could be shearing, crushing or abrasion, or other injuries due to relative movement of the elevator equipment. While this occurrence type is quite possible, there is also a rare chance of an elevator personnel not being able to prevent or activate movement of the elevator equipment. These occurrence types and others are listed in Table 1.

TABLE 1
Example: Occurrence types for the Standard Inspection Order ‘Pit stop
additional required’ in the elevating devices program

| No. | Likelihood | Occurrence Type |
|---|---|---|
| 1 | Possible | Improper exposure to moving equipment in the |
| | | hoistway |
| 2 | Imminent | General regulatory requirements |
| 3 | Rare | Improper exposure to moving equipment in the |
| | | hoistway |
| 4 | Possible | Loss of balance (falling into pit) |

It is possible to quantify whether an occurrence type could materialize in less than one day, one day to one year, one year to three years, three years to 25 years, or at various other time intervals as may be applicable to certain implementations of the invention. 25 years can be assumed to be the approximate service life of an elevating device. This potential is then translated into units of occurrences per year. Furthermore, the type of building that a device is installed in is considered in order to account for the exposure of that device to the public.

In one example, there are four likelihood grades, and associated time ranges within which a hazard could realize assuming that a typical device would be used 52 weeks in a year and 6 days a week. These grades are listed in Table 2. The time to an occurrence is considered as the [1-operational cycles/max operational cycles] percentile of Unif(a; b) where a and b are chosen from Table 2 for a particular occurrence type. The operational cycles are chosen from Table 3 and the max operational cycles refers to that of a hospital. This scheme is chosen so as to reflect the fact that building types with larger usage cycles are proportionally at higher risk than the less frequently used ones. For example, time to a rare occurrence in an assembly based on this scheme would be 22.8 years.

TABLE 2
Assumed likelihood grades to qualify occurrence types

| Likelihood | Likelihood | Time Horizon | Min (yrs) | Max (yrs) |
|---|---|---|---|---|
| ID | Grade | for Hazard Realization | (a) | (b) |
| 4 | Imminent | 1 hour to 1 day | 0.0003 | 0.003 |
| 3 | Likely | 1 day to 1 year | 0.003 | 1 |
| 2 | Possible | 1 to 3 years | 1 | 3 |
| 1 | Rare | 3 to 25 years | 3 | 25 |

TABLE 3
Building types and approximate cycles per hour

| Building Type | Cycles/hr |
|---|---|
| Assemblies | 10 |
| Group home | 29.55 |
| Learning institution | 33.2 |
| Mass transportation | 42.1 |
| Mercantile | 42.1 |
| Industrial | 43.1 |
| Rental | 53 |
| Condominium | 57 |
| Office restricted access | 66.55 |
| Open to public office | 66.55 |
| Hotel | 67.1 |
| Student residence | 76 |
| Hospital | 100 |

The frequency of the occurrence type given a certain building type and likelihood is then determined as the reciprocal of the time to occurrence. Hence, given a clause k, one of its associated occurrence types j and the building type, the corresponding frequency is denoted by λₖⱼ and expressed in terms of occurrences per day for convenience in decision making.

The next step involved assessing the health consequence of each occurrence type. Probabilities of injury severity (no injury, minor injury, serious injury, fatality) were observed and developed for each occurrence type. These probabilities were combined with point estimates of each injury severity, expressed in Disability-Adjusted Life-Years (DALYs), to get a health impact measure for each occurrence type. Finally, the resultant DALY and the potential occurrences per year for each occurrence type were combined to give the overall risk of the occurrence type as it pertains to the inspection order.

Inspections in the regulatory system could be considered as instruments that can identify non-compliances against acts and regulations. Alternatively, they could be viewed as an opportunity to preemptively prevent system failures that could potentially result in injuries or fatalities. The severity of a non-compliance can be equated to the burden of injuries and fatalities averted through the inspection program. The DALY is a valuable metric to quantify the burden avoided. Hence, in this application, the severity of an occurrence type is expressed in terms of the DALY metric—defined earlier. Applicant has identified 29 injury types, one or more of which are often experienced by injured victims while interfacing with a regulated technical system or product. The intent is to utilize DALY in a decision-making setting as a single dimensional metric resulting from aggregating morbidity and mortality outcomes. An injury sustained can have either or both of short-term and long-term health impacts. The expression for calculation of DALYs herein used is:

DALY=Short-term Weight*Short-term Duration+Long-term Weight*(Fraction Long-term*Long-term Duration) (3)

The weights were in-turn adapted from the Global Burden of Disease (GBD) studies at the World Health Organization (Begg et al., 2003). The long-term duration is the average life expectancy of the victim at the time of the occurrence. Table 4 lists some of the injury types and the corresponding weights and durations.

TABLE 4
Sample injury types and corresponding weights

| | Short-term | Short-term | Fraction | Long-term |
|---|---|---|---|---|
| Injury Type | Weight | Duration | Long-term | Weight |
| Fatal injury | 1 | 0 | 1 | 1 |
| No Injury | 0 | 0 | 0 | 0 |
| Aches or pains | 0.02 | 0.02 | 0 | 0 |
| Amputation | 0.174 | 0 | 1 | 0.174 |
| Bruise hemorrhage | 0.2 | 0.0425 | 0 | 0 |

An injury type is further classified as either permanent or non-permanent injury based on whether it influences the life expectancy of the victim. The entire list of categorized relevant injury types is listed in Table 5. The health impact of an occurrence type in terms of the DALY measure is obtained through a simulation process. It is assumed that there is either zero or single victim using the system or product at the time of the occurrence. It is assumed that experiencing one injury type is not dependent on any other injury type. The age of the victim is sampled from the age distribution of the population of Ontario. The victim, if injured, could simultaneously sustain up to four of the 29 injury types. The choice of the injury type category at the time of simulation is based on a discrete probability distribution. An example is cited in Table 6 in the context of elevating devices referring to the sample occurrence types in Table 1.

Once a category is chosen, an injury type within the category is chosen with equally likely probability and without replacement. The result of the simulation is a relative frequency distribution of DALYs whose mean statistic Sₖⱼ for a given clause k and occurrence type j is considered as quantified severity. Equation 3 is quantified for each injury type sustained and summed up to obtain the total health impact of a suffering victim. This is termed as the ‘Inferred DALY’.

TABLE 5
Injury Types by Category

| Permanent | Non-Permanent |
|---|---|
| Injury Types | Injury Types |
| Amputation | Aches or pains |
| Burns minor | Bruise hemorrhage |
| Burns severe | Dislocation of limb |
| Injury leading to deafness | Electric shock minor |
| Spinal injury | Exposure Carcinomatou Poison |
| Concussion | External bruise |
| Electric shock severe | Fracture nose fingers |
| Eye injury | Laceration deep cut |
| Fracture major bone | Laceration superficial |
| Heart attack | Nausea dizziness |
| Whiplash | Other internal injury |
| | Poisoning |
| | Respiratory infection |
| | Seizure |
| | Skin infection irritation |
| | Sprained or twisted |
| | Swelling |

TABLE 6
Occurrence type to DALY mapping

| Occurrence | | Permanent | Non-Permanent | No | Inferred |
|---|---|---|---|---|---|
| Type | Fatality | Injury | Injury | Injury | DALY |
| 1, 3 | 0.1% | 60% | 39.9% | 0% | 0.26 |
| 2 | 0% | 0% | 0% | 100% | 0.00001 |
| 4 | 0.1% | 25% | 74.9% | 0% | 5.7 |

Table 7 lists the DALY for an expected injury type category.

TABLE 7
DALY for each injury type category

| | |
|---|---|
| No Injury | 0.00001 |
| Non-Permanent Injury | 0.0014 |
| Permanent Injury | 0.8 |
| Fatality | 44.4 |

The 44.4 for fatality is obtained by setting the long-term duration in Equation 3 as the life expectancy of an average resident of Ontario, Canada and other parameters are set using the values in Table 4. The DALY values for non-permanent and permanent injury types are also calculated using Equation 3 and Table 4 except that non-permanent injury type do not factor the life expectancy in the equation. The threshold of risk for the purposes of decision making is assumed to be the product of percentage chance pⱼᵢ of observing a particular injury type category listed in Table 6 and the DALY value Dᵢ shown in Table 7. The index j refers to the occurrence type and i refers to one of the injury type categories fatal (F), non-permanent injury (N) and permanent injury (P):

thresholdⱼᵢ=pⱼᵢDᵢ,j=1,2, . . . ,n;iε{N,F,P} (4)

The trending risk for a given occurrence type is deemed to be unacceptable at a point in time when it reaches a certain predetermined threshold. The injury type category given a particular occurrence type j that poses the maximum risk is chosen as the threshold for the occurrence type and the threshold is given using Equation 5:

$${M}_{j} = {max}_{i ∈ \{ F , N , P \}} {p}_{ji} {D}_{i} , \\ j = 1 , 2 , … n \qquad ( 5 )$$

The above-described method may be applied for all regulated technical systems and products. The method is highly generic to the extent that only specific details of frequency and clause-occurrence types need to be tailored to the regulated system or product. The example and results that follow are selected from an elevating devices implementation, with a clause type “pit stop additional required” and the building type ‘Assemblies’ is chosen for this example. The clause has four possible occurrence types as listed in Table 1.

FIGS. 11 to 1 show the risk curve of each of the occurrence types using Equation 1. The profiles are relatively straight lines as opposed to being a curve within a 90 day window due to the small DALY values. The constant DALY values calculated using Equation 4 and Table 6 treated as thresholds of different injury type categories are also plotted as horizontal lines in these plots. Mⱼ denotes the horizontal line representing maximum risk for the corresponding occurrence type.

Table 8 lists the pⱼᵢDᵢ for each occurrence type and injury type category. The DALY values that are expected to occur beyond a 90 day period are negated for convenience. The value of Mⱼ is bolded for readability. The corresponding days after which these DALYs are expected is shown in Table 9 and bolded as well. As per Equation 2, the time-to-compliance corresponds to the minimum of all the bolded values in Table 9. Hence, when an inspector finds that an additional pit stop is required for an elevator, the optimal time-to-compliance determined by the proposed method is 2.2 days implying that the occurrence type ‘improper exposure to moving equipment in the hallway’ poses a non-permanent injury risk to the general public within couple of days. If non-permanent injuries are, however, assumed to be within tolerance levels, the next time-to-compliance would be 36.5 days foreseeing a permanent injury.

TABLE 8
DALY at Time-to-Occurrence for each Occurrence Type

| Non-Permanent | Permanent | | |
|---|---|---|---|
| Injury | Injury | Fatal | Occurrence Type |
| 0.0006 | −0.02 | −0.04 | 1 |
| −0.00001 | −0.00001 | −0.00001 | 2 |
| 0.0006 | −0.003 | −0.04 | 3 |
| 0.001 | 0.2 | 0.04 | 4 |

TABLE 9
Time-to-Occurrence (days) for each Occurrence Type

| Non-Permanent | Permanent | Fatal | Occurrence Type |
|---|---|---|---|
| 2.2 | 91.0 | 190.9 | 1 |
| 91.0 | 91.0 | 91.0 | 2 |
| 17.8 | 91.0 | 1554.3 | 3 |
| 0.2 | 36.5 | 8.0 | 4 |

The time-to-compliance aspect of the invention proposes a generic method to determine a risk-based time-to-compliance for regulated technical systems and products. The developed method is based on sound risk principles that account for likelihood and severity of various occurrence mechanisms leading to a non-compliance and then defines unacceptable risk thresholds that help in deciding on the number of days by which a customer has to comply to the set regulations. The method has been implemented for the special case of elevating devices to prove applicability of the model in day-to-day regulatory decision making.

Other modifications to and variations of the invention are also contemplated, and the invention is not to be considered limited by the examples described above.

What is claimed is:

1. A method for determining a risk of mechanical or electrical failure and for determining an inspection interval to mitigate said risk; the method comprising:
determining by a computer system an acceptable risk score based on computer readable instructions provided on a non-transitory computer readable medium;
determining by said computer system an inspection interval based on said risk score;
determining by said computer system a tolerance within said inspection interval based on said increased risk; and,
specifying by said computer system an inspection interval and an inspection tolerance based on said determined schedule and said determined tolerance;
wherein said step of determining an inspection interval comprises calculating an inspection interval tₘ or tₗ based on equations (3) and (4) for medium and low risk devices, respectively:
$$\begin{matrix}{t}_{M} = 12 - \frac{1}{0.7} LN [ \frac{λ}{6.7 \times {10}^{- 6}} ] & ( 3 ) \\ {t}_{L} = 18 - \frac{1}{1.21} LN [ \frac{λ}{4.713 \times {10}^{- 9}} ] & ( 4 )\end{matrix}$$
where tₘ and t_{L} are measured in months, and λ is an acceptable risk score;
and wherein said step of determining of determining an acceptable risk score comprises calculating λ based on equation (5)
$${λ}_{d} = \frac{{\sum }_{i} {SRR}_{i} * {D}_{i}}{{\sum }_{i} {D}_{i}} \qquad ( 5 )$$
where
SRRᵢ is the ith operational risk score for the facility d
Dᵢ is the time duration in years between inspection dates corresponding to SRRᵢ₋₁ and SRRᵢ.

2. A method according to claim 1, wherein said operational risk score is calculated based on the equation (1):
SRR=f_{b}*D (1)
where f_{b} is the frequency of incident occurrences per year; and,
D is a measure of life years expected to be lost as a result of said occurrences by occurrence type, and is calculated based on equation (2):
D=SW*SD+FL*LW*LD (2)
where:
SW is a short-term weight,
SD is a short-term duration effect measured in years,
FL is a fraction representative of the long-term versus short-term effects,
LW is a long-term weight, and
LD is a long-term duration effect measured in years.

3. A method according to claim 1, wherein said method is applied to a fuel storage device or a fuel storage facility.

4. A method according to claim 1, wherein said high risk device is one where the value of D from equation (2) is equal to or greater than 4.5×10⁻⁴; said medium risk device is one where the value of D from equation (2) is between 4.5×10⁻⁴ and 6.7×10⁻⁶ and said low risk device is one where the value of D from equation (2) is less than 6.7×10⁻⁶.

5. A method according to claim 1, further comprising determining a cumulative time-dependent risk curve based equation (6)
R_{d}(t)=(λt)^{p}D (6)
where
R_{d}(t) is the cumulative risk up to time t for facility d.
λ_{d}=λ/D is the occurrence rate expressed as occurrences per year.
D=is a constant representing average health impact observed in any given year.
t is the time since the last inspection.
p is the shape factor independent of the facility, determined by fitting a statistical distribution to a dataset containing a time to first occurrence signifying underlying failure since the last periodic inspection;
wherein said time dependent risk curve is used to determine an increase in risk score from a time proportional to a time elapsed since a previous inspection.

6. A system for determining a risk of failure and for determining an inspection interval to mitigate said risk; the system comprising:
a module for determining an acceptable risk score;
a module for determining an inspection interval based on said risk score;
a module for determining an increase in risk score proportional to a time elapsed since an expected inspection in said inspection interval if said expected inspection has been missed;
a module for determining a tolerance within said inspection interval based on said increased risk; and,
a module for specifying an inspection interval and an inspection tolerance based on said determined schedule and said determined tolerance.
wherein said determining an inspection interval comprises calculating an inspection interval tₘ or tₗ based on equations (3) and (4) for medium and low risk devices, respectively:
$$\begin{matrix}{t}_{M} = 12 - \frac{1}{0.7} LN [ \frac{λ}{6.7 \times {10}^{- 6}} ] & ( 3 ) \\ {t}_{L} = 18 - \frac{1}{1.21} LN [ \frac{λ}{4.713 \times {10}^{- 9}} ] & ( 4 )\end{matrix}$$
where t_{M} and t_{L} are measured in months, and λ is an acceptable risk score;
and wherein said step of determining of determining an acceptable risk score comprises calculating λ based on equation (5)
$${λ}_{d} = \frac{{\sum }_{i} {SRR}_{i} * {D}_{i}}{{\sum }_{i} {D}_{i}} \qquad ( 5 )$$
where
SRRᵢ is the ith operational risk score for the facility d
Dᵢ is the time duration in years between inspection dates corresponding to SRRᵢ₋₁ and SRRᵢ.

7. The system according to claim 6, wherein said operational risk score is calculated based on the equation (1):
SRR=f_{b}*D (1)
where f_{b} is the frequency of incident occurrences per year; and,
D is a measure of life years expected to be lost as a result of said occurrences by occurrence type, and is calculated based on equation (2):
D=SW*SD+FL*LW*LD (2)
where:
SW is a short-term weight,
SD is a short-term duration effect measured in years,
FL is a fraction representative of the long-term versus short-term effects,
LW is a long-term weight, and
LD is a long-term duration effect measured in years.

8. The system according to claim 6, wherein the system is applied to a fuel storage device or a fuel storage facility.

9. The system according to claim 6, wherein said high risk device is one where the value of D from equation (2) is equal to or greater than 4.5×10⁻⁴; said medium risk device is one where the value of D from equation (2) is between 4.5×10⁻⁴ and 6.7×10⁻⁶ and said low risk device is one where the value of D from equation (2) is less than 6.7×10⁻⁶.

10. The system according to claim 6, further comprising determining a cumulative time-dependent risk curve based equation (6)
R_{d}(t)=(λt)^{p}D (6)
where
R_{d}(t) is the cumulative risk up to time t for facility d.
λ_{d}=λ/D is the occurrence rate expressed as occurrences per year.
D=is a constant representing average health impact observed in any given year.
t is the time since the last inspection.
p is the shape factor independent of the facility, determined by fitting a statistical distribution to a dataset containing a time to first occurrence signifying underlying failure since the last periodic inspection;
wherein said time dependent risk curve is used to determine an increase in risk score from a time proportional to a time elapsed since a previous inspection.
